(19) United States
(12) Patent Application Publication
(10) Pub. No.: US 2016/0320540 A1
(43) Pub. Date: Nov. 3, 2016

(54) A LIGHT GUIDING PLATE AND LCD DEVICE

(71) Applicant: SHENZHEN CHINA STAR OPTOELECTRONICS TECHNOLOGY CO., LTD, Shenzhen, Guangdong (CN)

(72) Inventors: Yuchun HSIAO, Shenzhen, Guangdong (CN); Guofu TANG, Shenzhen, Guangdong (CN); Yanxue ZHANG, Shenzhen, Guangdong (CN)

(21) Appl. No.: 14/413,140

(22) PCT Filed: Jan. 30, 2014
(86) PCT No.: PCT/CN2014/071847

§ 371 Date: Jan. 6, 2015

(30) Foreign Application Priority Data
Jan. 23, 2014 (CN) 201410033526.X

(51) Int. Cl. F21V 8/00; G02F 1/1333

(52) U.S. Cl. CPC G02B 6/0003; G02B 6/0065; G02B 6/0085; G02B 6/0073; G02F 1/133308; G02F 2001/133342

(57) ABSTRACT

The present invention discloses a light guiding plate and LCD device. The light guiding plate comprises a main body and multiple quantum dot fluorescent powder formed uniformly in the main body. According to the light guiding plate, the colour saturation can be improve while no using quantum bars, the cost can be reduced and the assembly process can be simplified.

### FIELD OF THE INVENTION

The present invention relates to a light guiding plate and LCD (liquid crystal display) device.

### BACKGROUND OF THE INVENTION

With the development of LCD technology, the application of LCD products become wide. The existing devices are mostly of single-sided. In addition, it is also known that quantum bars are used to improve the colour saturation of the LCD device.

### SUMMARY OF THE INVENTION

The present invention provides a light guiding plate, which can improve the colour saturation without using quantum bars.

The present invention is realized in such a way that: a light guiding plate, the light guiding plate comprising a main body and multiple quantum dot fluorescent powder formed uniformly in the main body.

Preferably, the main body is a plate formed of PMMA.

Preferably, the main body is a plate formed of the blend of PMMA and PC.

Preferably, the light guiding plate is formed by means of mixing the main body in molten state with the multiple quantum dot fluorescent powder.

According to another aspect of the present invention, there is provided a LCD device, the LCD device comprising a light guiding plate, an optical film, a LED lighting source, a liquid crystal glass, a plastic frame and housing, the light guiding plate comprising a main body and multiple quantum dot fluorescent powder formed uniformly in the main body.

Preferably, the main body is a plate formed of PMMA.

Preferably, the main body is a plate formed of the blend of PMMA and PC.

Preferably, the light guiding plate is formed by means of mixing the main body in molten state with the multiple quantum dot fluorescent powder.

Preferably, the LCD device further comprising a heat sink, the LED lighting source is mounted on the heat sink and the LED lighting source is located beside the light guiding plate.

Preferably, the LCD device is a double-sided liquid crystal display device.

Preferably, the light guiding plate, the optical film and the liquid crystal glass are secured in the housing by the plastic frame; the housing is connected with the plastic frame by a plurality of screws.

Preferably, the housing is fitted with a decorative frame for covering the plurality of screws.

According to the present invention, the light guiding plate comprises a main body and multiple quantum dot fluorescent powder formed uniformly in the main body, the colour saturation can be improve while no using quantum bars.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic sectional view of the light guiding plate according to an embodiment of the present invention;

FIG. 2 is a schematic sectional view of the LCD device having the light guiding plate in FIG. 1;

FIG. 3 is a schematic partial sectional view of a traditional LCD device; and

FIG. 4 is a view of the LCD device in FIG. 3 showing the relative positions of quantum bars and LED lighting source.

### DETAILED DESCRIPTION OF THE PREFERRED EMBODIMENTS

The embodiments of the present invention will be described in detail with reference to the accompanying drawings.

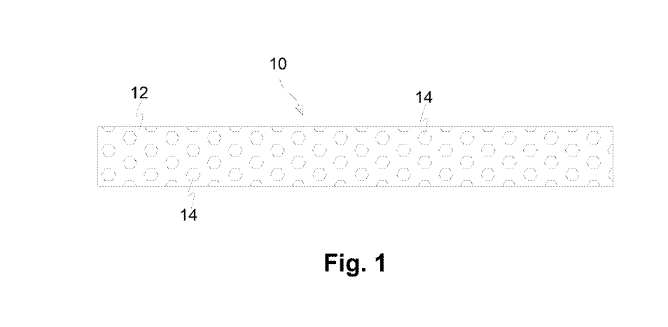

As shown in FIG. 1, the light guiding plate 10 in this embodiment comprises a main body 12 and multiple quantum dot fluorescent powder 14 formed uniformly in the main body 12. In the present embodiment, the light guiding plate 10 is formed by means of mixing the main body 12 in molten state with the multiple quantum dot fluorescent powder 14. The main body 12 is a plate formed of PMMA (PolymethylMethacrylate) or a plate formed of the blend of PMMA and PC (Polycarbonate).

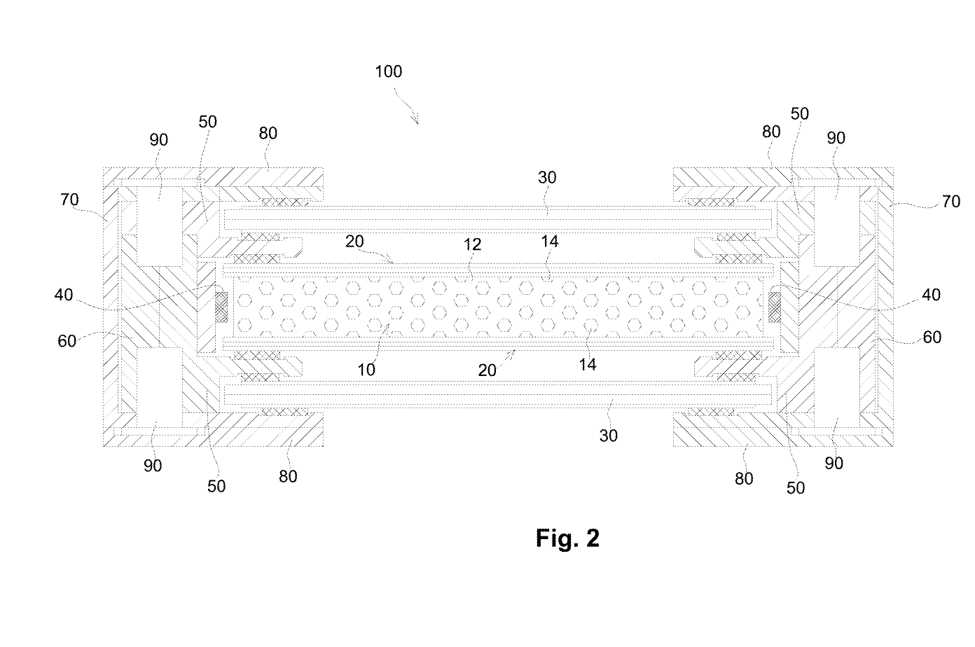

As shown in FIG. 2, the LCD device 100 of the embodiment comprises a light guiding plate 10, an optical film 20, a LED lighting source 40, a liquid crystal glass 30, a plastic frame 50, a heat sink 60 and a housing 70. The light guiding plate 10 comprises a main body 12 and multiple quantum dot fluorescent powder 14 formed uniformly in the main body 12, as described above.

In the present embodiment, the LED lighting source 40 is mounted on the heat sink 60 and the LED lighting source 40 is located beside the light guiding plate 10. Moreover, the light guiding plate 10, the optical film 20 and the liquid crystal glass 30 are secured in the housing 70 by the plastic frame 50, the housing 70 is connected with the plastic frame 50 by a plurality of screws 90. In additional, the housing 70 is fitted with a decorative frame 80 for covering the plurality of screws 90. As shown in FIG. 2, on the both sides of the light guiding plate 10, the optical film 20 and the liquid crystal glass 30 are provided. The LCD device 100 is a double-sided liquid crystal display device.

In the assembly of double-sided LCD device 100 as shown in FIG. 2, first of all, the LED lighting source 40 is mounted on the heat sink 60, and then the light guiding plate 10 and the optical film 20 are disposed perpendicular to the heat sink 60. Then, the optical film 20 and the liquid crystal glass 30 are secured in the housing 70 using the plastic frame 50. Then, the housing 70 is connected with the plastic frame 50 using a plurality of screws 90. Finally, the housing 70 is fitted with a decorative frame 80 to cover the plurality of screws 90. In one embodiment of the light guiding plate 10, the size of the quantum dot fluorescent powder 14 is about several nanometres. The light guiding plate 10 is formed by means of mixing the main body 12 in molten state with the multiple quantum dot fluorescent powder 14.

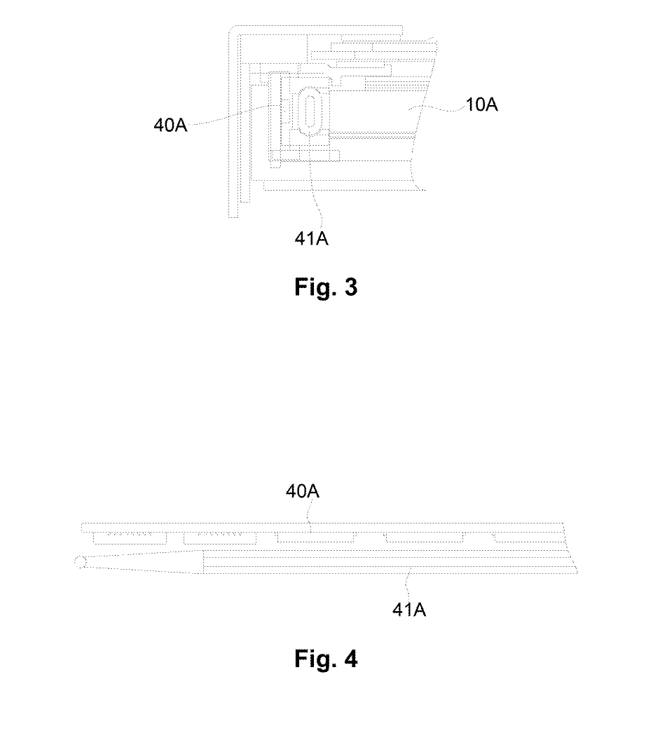

As shown in FIG. 3 and FIG. 4, in the traditional LCD device, A quantum bar 41A are provided between the light guiding plate 10A and the lighting source 40A to improve the colour saturation of the LCD device. According to the present invention, the colour saturation can be improve while no using quantum bars, the cost can be reduced and the assembly process can be simplified.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A light guiding plate, comprising a main body and multiple quantum dot fluorescent powder formed uniformly in the main body.

2. The light guiding plate of claim 1, wherein the main body is a plate formed of PMMA.

3. The light guiding plate of claim 1, wherein the main body is a plate formed of the blend of PMMA and PC.

4. The light guiding plate of claim 1, wherein the light guiding plate is formed by means of mixing the main body in molten state with the multiple quantum dot fluorescent powder.

5. A LCD device, comprising a light guiding plate, an optical film, a LED lighting source, a liquid crystal glass, a plastic frame and a housing, the light guiding plate comprising a main body and multiple quantum dot fluorescent powder formed uniformly in the main body.

6. The LCD device of claim 5, wherein the main body is a plate formed of PMMA.

7. The LCD device of claim 5, wherein the main body is a plate formed of the blend of PMMA and PC.

8. The LCD device of claim 5, wherein the light guiding plate is formed by means of mixing the main body in molten state with the multiple quantum dot fluorescent powder.

9. The LCD device of claim 5, further comprising a heat sink, wherein the LED lighting source is mounted on the heat sink and the LED lighting source is located beside the light guiding plate.

10. The LCD device of claim 5, wherein the LCD device is a double-sided liquid crystal display device.

11. The LCD device of claim 5, wherein the light guiding plate, the optical film and the liquid crystal glass are secured in the housing by the plastic frame, the housing is connected with the plastic frame by a plurality of screws.

12. The LCD device of claim 11, wherein the housing is fitted with a decorative frame for covering the plurality of screws.
